(19) United States
(12) Patent Application Publication
(10) Pub. No.: US 2015/0382295 A1
(43) Pub. Date: Dec. 31, 2015

(54) METHOD FOR GROUP UPDATE OF ASSOCIATIONS BETWEEN ADDRESSES OF A MOBILE TERMINAL

(71) Applicant: ORANGE, Paris (FR)

(72) Inventors: Ali Ahmad Hassan, Rennes (FR); Meryem Ouzzif, Mordelles (FR); Philippe Bertin, Acigne (FR)

(21) Appl. No.: 14/765,560

(22) PCT Filed: Feb. 14, 2014
(86) PCT No.: PCT/FR2014/050303

§ 371 Date: Aug. 3, 2015

(30) Foreign Application Priority Data
Feb. 15, 2013 (FR) 1351292

(51) Int. Cl. H04W 52/02; H04W 60/00; H04L 12/803; H04W 28/06

(52) U.S. Cl. CPC H04W 52/0209; H04W 28/06; H04W 60/005; H04L 47/125; H04W 80/04

(57) ABSTRACT

The invention relates to a method for transmitting a message for updating associations between at least one first address and one second address of a mobile terminal, implemented by a mobile terminal attached, by a plurality of first addresses, to first devices of at least one first packet-switching mobile communication network, said first devices being capable of directing a plurality of communication flows toward the mobile terminal, the method including: a step of obtaining a second address when the mobile terminal is attached to a second device of a second network; a step of generating a group update message, including individual information relating to the plurality of first devices, and information relating to the second device; a step of transmitting the group message to a management device previously associated with the mobile terminal and capable of generating and transmitting individual update messages, from the group update message, to the first devices.

### 1. FIELD OF THE INVENTION

The patent application lies in the field of packet-switched mobile communication networks, and more particularly that of roaming of a mobile terminal to a network that is not its usual network.

### 2. PRIOR ART

In the mobile communication networks based on the IP Internet Protocol according to the IETF (Internet Engineering Task Force) standards and more particularly the MIPv6 (Mobile IPv6) standards, a mobile terminal is associated with a Home Network, which assigns it an IP address enabling it to be localized by its Home Network, known as its Home Address, when the terminal is located in its Home Network. When the mobile terminal is in a situation of roaming in a Foreign Network, this address is not enough to localize the mobile terminal. The Foreign Network must further assign it a second IP address, known as the Care-of Address (CoA). It is the association between the Home Address and this CoA that enables the Home Network to find the mobile terminal, wherever it may be.

This CoA changes each time the mobile terminal leaves the area covered by a network to enter an area covered by another network. Each time the mobile terminal changes CoA, it must notify its Home Network, which can only correctly localize it provided that it knows the most recent CoA thereof.

This notification is made via an update message called a Binding Update, which has the effect of updating the association between the CoA and Home Address. In the Home Network, the device responsible for localizing the mobile terminal is called the Home Agent. It is this that receives the Binding Updates, updates the associations, and sends back acknowledgments to the mobile terminal in response.

According to the work of the DMM (Distributed Mobility Management) working group of the IETF, based on MIPv6, each access router is provided with Home Agent functionalities. Consequently, the mobile terminal may have multiple Home Addresses with multiple Home Agents, which is increasingly common with the multiplication and specialization by application domain of packet-switched mobile networks. It must therefore issue Binding Updates to each of its Home Agents, which will each respond with an acknowledgment. This is illustrated by FIG. 1, where three Home Agents HA1, HA2 and HA3 receive the Binding Updates BU1, BU2 and BU3 respectively from the terminal MN. In response, they transmit the acknowledgment messages BA1, BA2 and BA3 respectively to the terminal MN.

As all these signaling messages are transmitted and received by the mobile terminal, they occupy a significant portion of the radio channels used between the terminal and the first mobile network access routers, channels that constitute a scarce and valuable resource. In addition, the transmission of all these messages helps reduce the battery life of the mobile terminal.

One of the purposes of the invention is to overcome drawbacks of the prior art.

### 3. DISCLOSURE OF THE INVENTION

The invention is set to improve the situation using a method for transmitting a message for updating associations between at least one first address and one second address of a mobile terminal, implemented by a mobile terminal attached by a plurality of first addresses to first devices of at least one first packet-switched mobile communication network, said first devices being capable of directing a plurality of communication flows to the mobile terminal, the method including
a step of obtaining a second address when the mobile terminal is attached to a second device of a second network,
a step of generating a bundled update message, including individual information relating to the plurality of first devices, and information relating to the second device,
a step of transmitting the bundled message to a management device previously associated with the mobile terminal and capable of generating and transmitting individual update messages, from the bundled update message, to the first devices.

Thanks to the method of transmitting according to the invention, the mobile terminal only transmits a single update message, whereas according to the prior art, a plurality of update messages are transmitted. The congestion of the radio link via which the mobile terminal transmits is thus reduced, and the battery of the terminal is spared.

For example, the first network is the network of the operator to which the terminal user is subscribed, termed the Home Network, the first devices are Home Agents, the first addresses are Home Addresses, the second network is a foreign network in which the terminal user is roaming, termed the Foreign Network, the second device is a router of a Foreign Network, the second address is the Care-of Address allocated to the mobile terminal by the second device, and the individual update message is a Binding Update. Instead of sending to each of the Home Agents a Binding Update including, among other parameters, the Care-of Address, the terminal only sends a single message similar to a modified Binding Update, to a management device which itself will be responsible for sending the Binding Updates corresponding to each of the Home Agents.

This runs counter to the preconceptions of the person skilled in the art since one of the objectives of the protocols managing the change of IP address of a terminal according to its mobility, i.e. IP mobility, is, in particular in the IETF, to move the bulk of the processing and operations to the periphery of networks, i.e. to the user terminals. This prior art, however, created an undesirable side effect, namely an overload of the terminal portion of the connection between the mobile terminal and its first network access router. It is recalled that this terminal portion is a radio link. The invention therefore solves the problem of overloading the radio link by shifting a portion of the mobility-related operations from the terminal to a management device.

According to one aspect of the invention, the method for transmitting an update message includes a step of discovering the management device by the mobile terminal.

Thus, the mobile terminal has the possibility of setting up the association autonomously by modifying an existing discovery protocol, which avoids it having to resort to the solution of the prior art consisting in transmitting the plurality of individual update messages itself and thus overloading a radio link.

According to one aspect of the invention, the step of generating a bundled message is preceded by the following steps:
a step of generating a plurality of individual update messages,
a step of inhibiting the transmission of the plurality of individual update messages to the first devices,
a step of extracting individual information relating to the plurality of first devices, and information relating to the second network, from individual update messages.

Thus, the method according to the prior art, optionally implemented by the mobile terminal, has no need to be eliminated or modified. The method according to the prior art is, for example, the sending of individual Binding Updates to each of the Home Agents.

The steps of the method according to the invention are simply added to the existing steps, which simplifies the upgrading of mobile terminals to make them conform to the invention.

The various aspects of the method for transmitting an update message which have just been described may be implemented independently from each other or in combination with each other.

The invention also relates to a method for unbundling a message for updating associations between at least one first address and one second address of a mobile terminal, implemented by a management device of a packet-switched mobile communication network, the mobile terminal being attached by a plurality of first addresses to first devices of at least one first packet-switched mobile communication network, said first devices being capable of directing a plurality of communication flows to the mobile terminal, the method including:
a step of receiving a bundled update message from the mobile terminal, the bundled message including individual information relating to the plurality of first devices, and information relating to a second device of a second network,
a step of generating a plurality of individual update messages, from the bundled message,
a step of transmitting the plurality of individual update messages to the first devices.

Thanks to the method for unbundling an update message, the management device ensures that the update messages that are received by the Home Agents are the same as those that they would have received according to the prior art, i.e. Binding Updates received directly from the mobile terminal. Thus, no modification of the Home Agents is necessary.

According to one aspect of the invention, the generating step of the unbundling method includes:
a step of reproducing the bundled message in a plurality of reproduced messages,
and, for each first device of the plurality, a step of eliminating, in one of the reproduced messages, all the individual information except that relating to the first device concerned.

Thus, the step of generating individual messages, e.g. the step of generating Binding Updates, is simplified by the reuse of information received. The implementation of these steps in an existing device, e.g. in a modified Home Agent is thereby easier.

The invention also relates to a device for transmitting a message for updating associations between at least one first address and one second address of a mobile terminal, implemented by a mobile terminal attached by a plurality of first addresses to first devices of at least one first packet-switched mobile communication network, said first devices being capable of directing a plurality of communication flows to the mobile terminal, the device including:
a module for obtaining a second address when the mobile terminal is attached to a second device of a second network,
a module for generating a bundled update message, including individual information relating to the plurality of first devices, and information relating to the second device,
a module for transmitting the bundled message to a management device capable of generating and transmitting individual update messages, from the bundled update message, to the first devices.

This device may be implemented in a mobile terminal.

The invention also relates to a device for unbundling a message for updating associations between at least one first address and one second address of a mobile terminal, implemented by a management device of a packet-switched mobile communication network, the mobile terminal being attached by a plurality of first addresses to first devices of at least one first packet-switched mobile communication network, said first devices being capable of directing a plurality of communication flows to the mobile terminal, the device including:
a module for receiving a bundled update message from the mobile terminal, the bundled message including individual information relating to the plurality of first devices, and information relating to a second device of a second network,
a module for generating a plurality of individual update messages, from the bundled message,
a module for transmitting the plurality of individual update messages to the first devices.

This device can be implemented in any network device, but it may be advantageous to do so in an existing device, in particular in an existing device with which the mobile terminal is associated or which it can easily discover, such as, for example, a modified Home Agent.

The invention also relates to a mobile terminal of a packet-switched mobile communication network, implementing the device for transmitting an update message that has just been described.

The invention also relates to a management device of a packet-switched mobile communication network, implementing the device for unbundling an update message that has just been described.

According to one aspect of the invention, the management device further includes a transmitting module capable of directing a communication flow to the mobile terminal.

The unbundling device may be implemented in a device capable of directing a communication flow to the mobile terminal, such as, for example, a Home Agent. Advantageously, the device thus does not require any special equipment, and its association with the mobile terminal is easy to implement.

The invention also relates to a system for updating associations between at least one first address and one second address of a mobile terminal, including said mobile terminal and a management device, the mobile terminal being attached by a plurality of first addresses to first devices of at least one first packet-switched mobile communication network, said first devices being capable of directing a plurality of communication flows to the mobile terminal, the mobile terminal including:
a module for obtaining a second address when the mobile terminal is attached to a second device of a second network,
a module for generating a bundled update message, including individual information relating to the plurality of first devices, and information relating to the second network,
a module for transmitting the bundled update message to the management device,
   the management device including:
a module for receiving said bundled update message,
a module for generating a plurality of individual update messages, from the bundled update message,
a module for transmitting the plurality of individual update messages, to said first devices.

Thanks to this updating system, the individual Binding Updates according to the prior art are no longer transmitted directly by the mobile terminal and consequently no longer cause congestion on the radio link attaching it to the network.

The invention also relates to a signal carrying a bundled message for updating associations between a plurality of first addresses of a mobile terminal in at least one first packet-switched mobile communication network, and a second address of a mobile terminal in a second packet-switched mobile communication network, the bundled message being intended for a management device and including the second address and a plurality of information relating to the first networks, the bundled message being further capable of triggering the generation and transmission, by the receiving management device, of individual update messages to the devices of the at least one first network, said devices being capable of directing a plurality of communication flows to the mobile terminal.

The bundled message carried by the signal is, for example, a new type of ‘bundled’ Binding Update, including the information required for generating corresponding individual Binding Updates. The second address is, for example, the Care-of Address, and the individual information relating to the first networks is, for example, the addresses of the Home Agents to which the Binding Updates are intended to be transmitted.

The technical effect of the signal carrying a bundled message is to trigger a series of operations resulting in the reception of individual messages by devices for which it is apparent that the individual messages have been transmitted by the mobile terminal directly. In this way, not only do the individual messages no longer cause congestion on the radio link of the mobile terminal, but no modification is necessary on the devices receiving individual messages.

The invention also relates to a computer program including instructions for implementing the steps of the method for transmitting an update message that has just been described, when this method is executed by a processor.

The invention also relates to a recording medium readable by a mobile terminal whereon the program just described is recorded, which is able to use any programming language, and be in the form of source code, object code, or intermediate code between source code and object code, such as in a partially compiled form, or in any other desirable form.

The invention also relates to a computer program including instructions for implementing the steps of the method for unbundling an update message that has just been described, when this method is executed by a processor.

The invention finally relates to a recording medium readable by a management device whereon the program just described is recorded, which is able to use any programming language, and be in the form of source code, object code, or intermediate code between source code and object code, such as in a partially compiled form, or in any other desirable form.

### 4. DESCRIPTION OF THE FIGURES

Other advantages and features of the invention will appear more clearly on reading the following description of a particular embodiment of the invention, given as a simple illustrative and non-restrictive example, and the accompanying drawings, in which:

FIG. 1 schematically depicts a system for updating associations between at least one first address and one second address of a mobile terminal, according to the prior art,

FIG. 2 schematically depicts a system for updating associations between at least one first address and one second address of a mobile terminal, according to the invention,

FIG. 3 schematically depicts an example of implementation of the method for transmitting a message for updating associations between at least one first address and one second address of a mobile terminal, according to a particular embodiment of the invention,

FIG. 4 depicts an example of implementation of the method for unbundling a message for updating associations between at least one first address and one second address of a mobile terminal, according to a particular embodiment of the invention,

FIG. 5 depicts an example of structure of a device for transmitting a message for updating associations between at least one first address and one second address of a mobile terminal, according to one aspect of the invention,

FIG. 6 depicts an example of structure of a device for unbundling a message for updating associations between at least one first address and one second address of a mobile terminal, according to one aspect of the invention.

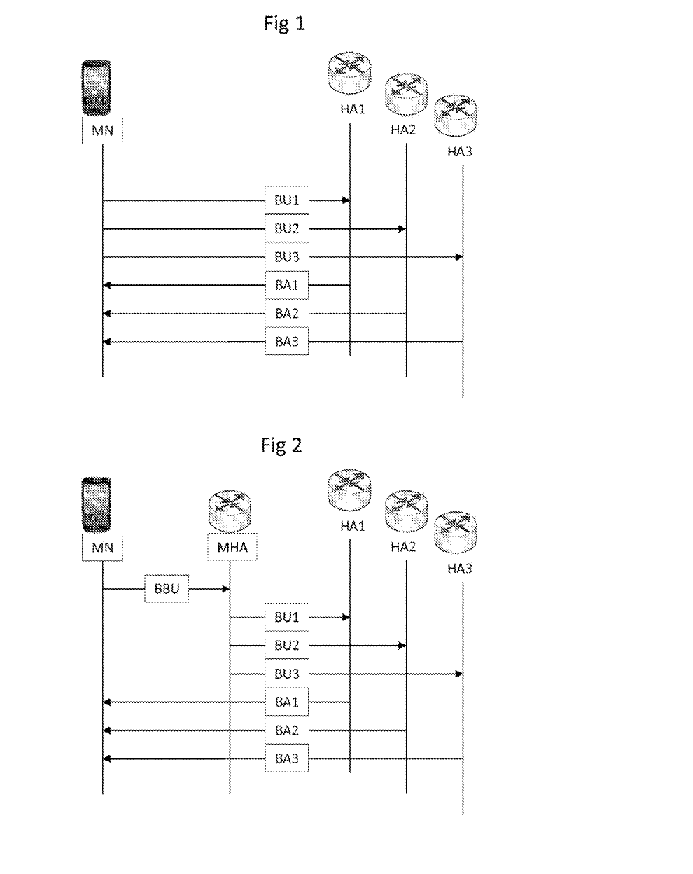

### 5. DETAILED DESCRIPTION OF AT LEAST ONE EMBODIMENT OF THE INVENTION

The rest of the description gives examples of embodiments of the invention based on MIPv6 DMM, but the invention also applies to any protocol where the mobile terminal can have multiple Home Agents simultaneously.

FIG. 2 schematically depicts a system for updating associations between at least one first address and one second address of a mobile terminal, according to the invention.

The mobile terminal MN, instead of transmitting as in the prior art Binding Updates to each of its Home Agents HA1, HA2 and HA3, transmits instead a single update message BBU (Bundled Binding Update message in English, for updating associations), to a management device MHA (Managing Home Agent). The management device MHA unbundles the message BBU received to generate and transmit the individual Binding Updates BU1, BU2 and BU3 to the three Home Agents HA1, HA2 and HA3. As the individual Binding Updates BU1, BU2 and BU3 are identical to the Binding Updates of the prior art, the Home Agents HA1, HA2 and HA3 react as if the Binding Updates had been transmitted directly by the mobile terminal MN. Accordingly, they transmit in response to the terminal MN the same acknowledgment messages BA1, BA2 and BA3 as in the prior art.

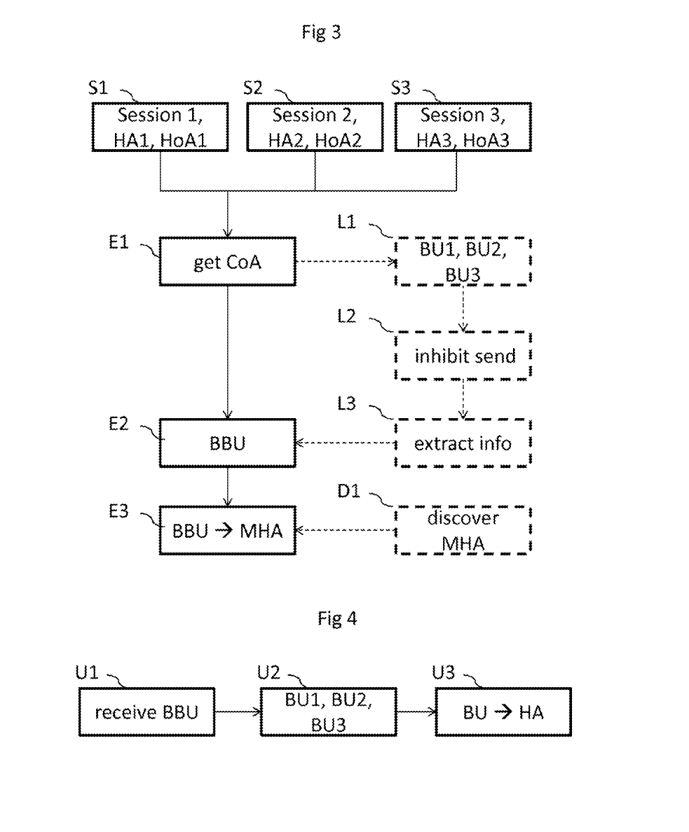

FIG. 3 depicts an example of implementation of the method for transmitting a message for updating associations between at least one first address and one second address of a mobile terminal, according to a particular embodiment of the invention.

In a known step S1, the mobile terminal MN has established a communication session with a remote device ED1, while it was attached to an access router of a first communication network. This first network is, for example, the network of the operator to which the terminal user is subscribed, termed the Home Network.

During the procedure for establishing said session, an address HoA1 (Home Address 1) has been assigned to the terminal MN by a device HA1 of the communication network. This device is, for example, an access router, called a ‘mobility anchor’ or also a ‘Home Agent’, capable of allocating an IP address to a mobile terminal attached to this network, and ‘carrying’ a session of this terminal.

In steps S2 and S3 similar to S1, the terminal MN has also established two other communication sessions while being attached to an access router of the first communication network.

These steps S1 through S3 together illustrate a case where, for example, the mobile terminal MN has established three different sessions with three different remote devices, said sessions being carried by three different mobility anchors, HA1 HA2 and HA3.

Steps S1 through S3 are preliminary to an event the consequence of which is an attachment of the terminal to an access router of a second network different from the first network, the event possibly being, for example, a mobility of the terminal MN outside the coverage of the first network.

In a known step E1, the mobile terminal MN is attached to an access router of a second network and obtains from it a new address CoA, called a Care-of Address. This second network is, for example, a Foreign Network in which the terminal user is roaming.

In a step E2, the mobile terminal MN generates a bundled update message BBU, including information indicating the association between its first addresses HoA1, HoA2 and HoA3, and its second address CoA. The structure of such a message is detailed later in table 2.

In a step E3, the mobile terminal MN transmits a signal carrying this single message BBU to a management device MHA previously associated with the terminal MN.

In an optional step D1 prior to step E3, the terminal MN has discovered the management device MHA among the access routers of the first network using a protocol similar to RFC 4861 (Neighbor Discovery for IPv6) or RFC 6275 (Mobility Support in IPv6), where one of the reserved bits is used to indicate that the access router also functions as a management device capable of receiving and processing such a message BBU.

The group of steps L1 through L3 is optional, consecutive to E1 and prior to E2.

In a step L1, the mobile terminal MN generates according to the prior art individual update messages BU1, BU2 and BU3.

The structure of these Binding Update messages in IPv6 is described in the standard RFC 6275 (MIPv6). The message BU1, for example, includes multiple portions, as illustrated in table 1 below.

TABLE 1
Structure of the Binding Update message
BU1 according to the standard RFC 6275

| Fields or subfields | Including, for example: |
|---|---|
| IPv6 Header | Source Address = CoA |
| | Destination Address = HA1 |
| Home Address Option | Home Address = HoA1 |
| IPsec Header | IPsec = IPsec1 |
| Mobility Header | identifies the type of message (=BU) and |
| | announces the remaining length of the |
| | message |
| Message Data | other information about the message, |
| | such as service life |
| Mobility Options | optional subfield of Message Data |

IPsec1 information is information characterizing the type of security of the link attaching the terminal MN to the Home Agent HA1 and the security level of the session carried by HA1.

In a step L2 the terminal MN inhibits the transmission of individual messages BU1, BU2 and BU3, in order not to cause congestion on the radio channel.

In a step L3 the terminal MN extracts from each of the individual messages BU1, BU2 and BU3 the information intended to generate the message BBU.

Step L3 is followed by step E2, where, as explained earlier, the mobile terminal MN generates a bundled update message BBU. The structure of such a message is detailed in table 2 below.

TABLE 2
Structure of the Bundled Binding Update message BBU

| Fields or subfields | Including, for example: |
|---|---|
| IPv6 Header | Source Address = CoA |
| | Destination Address = MHA |
| Home Address Option | Home Address = HoA-MHA |
| IPsec Header | IPsec = IPsec-MHA |
| Mobility Header | identifies the type of message (=BU) and |
| | announces the remaining length of the |
| | message |
| Message Data | other information about the message, |
| | such as service life |
| Mobility Options | Option 1: |
| | Type = 12, |
| | Length = Length1, |
| | Home Address = HoA1, |
| | Home Agent Address = HA1, |
| | IPsec = IPsec1 |
| | Option 2: |
| | Type = 12, |
| | Length = Length2, |
| | Home Address = HoA2, |
| | Home Agent Address = HA2, |
| | IPsec = IPsec2 |
| | Option 3: |
| | Type = 12, |
| | Length = Length3, |
| | Home Address = HoA3, |
| | Home Agent Address = HA3, |
| | IPsec = IPsec3 |

The structure of the Bundled Binding Update message BBU is the same as that of the Binding Update messages that is described in the standard RFC 6275.

The address HoA-MHA is that of the mobile terminal for the Managing Home Agent MHA. IPsec-MHA information is information characterizing the type of security of the link attaching the terminal MN to the Managing Home Agent MHA and the security level of the session carried by MHA.

The optional subfield Mobility Options is used for transporting useful information, transported according to the prior art in the IPv6 Header, Home Address Option and IPsec Header fields in the case of Binding Update messages. According to the invention, a new type of Mobility Option is created with, for example, a value equal to 12, so that the device receiving the message, e.g. the Managing Home Agent MHA, recognizes that the message is a ‘Bundled Binding Update’ and not a ‘Binding Update’ and can retrieve the useful information.

It is clear that for generating a Bundled Binding Update, it is easy to group the information included in individual Binding Updates, if these Binding Updates have already been generated.

FIG. 4 depicts an example of implementation of the method for unbundling a message for updating associations between at least one first address and one second address of a mobile terminal, according to a particular embodiment of the invention.

In a step U1, a management device MHA receives a signal carrying a message BBU from a mobile terminal MN. The message BBU described in table 2, includes, in the Mobility Options field, individual information relating to three Home Agents of a first network, each carrying a session of the mobile terminal MN, and in the IPv6 Header field, information, CoA, relating to a second network to which the terminal MN is attached.

In a step U2, the management device MHA generates three individual Binding Update messages BU1, BU2 and BU3, from information included in the message BBU.

In a step U3, the management device MHA transmits the messages BU1, BU2 and BU3 respectively to the Home Agents HA1, HA2 and HA3. The messages BU1, BU2 and BU3 are identical to those that would have been sent by the mobile terminal MN if it had transmitted them according to the prior art. The invention therefore does not require any modification of the Home Agents.

In a variant not illustrated, step U2 takes advantage of the identity of structure between the BBU type messages and the BU type messages, in order to simplify the generation of individual BU type messages in the following way. In a first substep, the message BBU is reproduced in triplicate BBU1, BBU2 and BBU3.

In a second substep relating to BBU1, all the information of the Mobility Options field of BBU1 is eliminated, except for HoA1, HA1 and IPsec1 which are respectively moved to the Home Address Options, IPv6 Header and IPsec Header fields of BBU1. The subfield ‘Source Address=CoA’ is kept, and the subfield Mobility Options is eliminated. Thus the message BU1 is obtained, ready to be transmitted.

The equivalent is performed on BBU2 and BBU3 in order to obtain BU2 and BU3.

A description is now given, in relation to FIG. 5, of an example of structure of a device for transmitting a message for updating associations between at least one first address and one second address of a mobile terminal, according to one aspect of the invention.

The device 100 for transmitting an update message implements the method for transmitting an update message, various embodiments of which have just been described.

Such a device 100 may be implemented in a mobile terminal capable of being connected to packet-switched mobile communication networks.

For example, the device 100 includes a processing unit 130, provided, for example, with a microprocessor μP, and controlled by a computer program 110, stored in a memory 120 and implementing the method for transmitting an update message according to the invention. On initialization, the code instructions of the computer program 110 are, for example, loaded into a RAM memory, before being executed by the processor of the processing unit 130.

Such a device 100 includes:
a receiving module 140, capable of receiving a message including an address (CoA) when the terminal is attached to a device of a packet-switched mobile communication network, originating from said device,
a generating module 150, capable of generating a bundled update message (BBU), including individual information relating to a plurality of networks to which the terminal was attached, and information relating to the network to which the terminal was last attached,
a transmitting module 160, capable of transmitting a signal carrying a bundled update message (BBU), intended for a management device capable of generating and transmitting individual update messages.

Advantageously, the processing unit 130 may include:
a discovery module 170, capable of discovering a management device capable of generating and transmitting individual update messages,
a generating module 171, capable of generating individual update messages,
an inhibiting module 172, capable of inhibiting the transmission of the generated individual update messages,
an extraction module 173, capable of extracting, from individual update messages, individual information relating to a plurality of networks to which the terminal was attached, and information relating to the network to which the terminal was last attached.

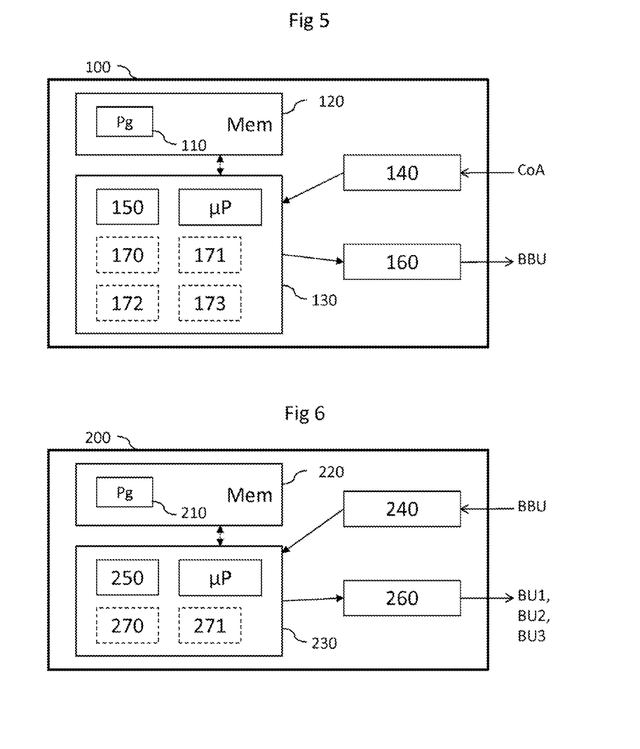

A description is now given, in relation to FIG. 6, of an example of structure of a device for unbundling a message for updating associations between at least one first address and one second address of a mobile terminal, according to one aspect of the invention.

The device 200 for unbundling an update message implements the method for unbundling an update message, the various embodiments of which have just been described.

Such a device 200 may be implemented in a management device of a packet-switched mobile communication network. For example, this management device may be capable of directing a communication flow to a mobile terminal. In particular, it may be a ‘Home Agent’ type of device.

For example, the device 200 includes a processing unit 230, provided, for example, with a microprocessor μP, and controlled by a computer program 210, stored in a memory 220 and implementing the method for transmitting an update message according to the invention. On initialization, the code instructions of the computer program 210 are, for example, loaded into a RAM memory, before being executed by the processor of the processing unit 230.

Such a device 200 includes:
a receiving module 240, capable of receiving a signal carrying a bundled update message (BBU), including individual information relating to a plurality of networks to which a terminal was attached, and information relating to a network to which the terminal was last attached,
a generating module 250, capable of generating individual update messages (BU1, BU2, BU3),
a transmitting module 260, capable of transmitting individual update messages (BU1, BU2, BU3), intended for devices to which the terminal is attached.

Advantageously, the processing unit 230 may include:
a reproduction module 270, capable of reproducing the bundled update message,
an elimination module 271, capable of eliminating, from a reproduced bundled update message, individual information relating to a plurality of networks to which the terminal is attached.

The modules described in relation to FIGS. 5 and 6 may be hardware or software modules.

The examples of embodiment of the invention that have just been described are only some of the conceivable embodiments. They show that the invention allows a mobile terminal having obtained a new address to notify this change to a plurality of devices to which it is attached, with the aid of a single message, thus reducing the congestion generated by the mobile terminal on the radio channels that it uses, as well as its battery consumption.

1. A method for transmitting a message for updating associations between at least one first address and one second address of a mobile terminal, implemented by a mobile terminal attached by a plurality of first addresses to first devices of at least one first packet-switched mobile communication network,
said first devices being capable of directing a plurality of communication flows to the mobile terminal, the method including a step of obtaining a second address when the mobile terminal is attached to a second device of a second network,
the method being characterized in that it further includes:
a step of generating a bundled update message, including individual information relating to the plurality of first devices, and information relating to the second device,
a step of transmitting the bundled message to a management device previously associated with the mobile terminal and capable of generating and transmitting individual update messages, from the bundled update message, to the first devices.

2. The method for transmitting an update message as claimed in claim 1, characterized in that
the method includes a step of discovering the management device by the mobile terminal.

3. The method for transmitting an update message as claimed in claim 1, characterized in that
the step of generating a bundled message is preceded by the following steps:
a step of generating a plurality of individual update messages,
a step of inhibiting the transmission of the plurality of individual update messages to the first devices,
a step of extracting individual information relating to the plurality of first devices, and information relating to the second network, from individual update messages.

4. A method for unbundling a message for updating associations between at least one first address and one second address of a mobile terminal, implemented by a management device of a packet-switched mobile communication network, the mobile terminal being attached by a plurality of first addresses to first devices of at least one first packet-switched mobile communication network,
said first devices being capable of directing a plurality of communication flows to the mobile terminal,
characterized in that
the method comprises:
a step of receiving a bundled update message from the mobile terminal, the
bundled message including individual information relating to the plurality of first devices, and information relating to a second device of a second network,
a step of generating a plurality of individual update messages, from the bundled message,
a step of transmitting the plurality of individual update messages to the first devices.

5. The method for unbundling an update message as claimed in claim 4, characterized in that
the generating step includes:
a step of reproducing the bundled message in a plurality of reproduced messages,
and, for each first device of the plurality, a step of eliminating, in one of the reproduced messages, all the individual information except that relating to the first device concerned.

6-10. (canceled)

11. A system for updating associations between at least one first address and one second address of a mobile terminal,
characterized in that it includes said mobile terminal and a management device, the mobile terminal being attached by a plurality of first addresses to first devices of at least one first packet-switched mobile communication network, said first devices being capable of directing a plurality of communication flows to the mobile terminal, the mobile terminal including:
a module for obtaining a second address when the mobile terminal is attached to a second device of a second network,
a module for generating a bundled update message, including individual information relating to the plurality of first devices, and information relating to the second network,
a module for transmitting the bundled update message to the management device,
the management device including:
a module for receiving said bundled update message,
a module for generating a plurality of individual update messages, from the bundled update message,
a module for transmitting the plurality of individual update messages, to said first devices.

12-14. (canceled)
